(19) United States
(12) Patent Application Publication
(10) Pub. No.: US 2018/0108205 A1
(43) Pub. Date: Apr. 19, 2018

(54) FUEL DISPENSING ENVIRONMENT WITH A DISTRIBUTED PROMOTION SYSTEM

(71) Applicant: Gilbarco Inc., Greensboro, NC (US)

(72) Inventors: Michael James Symonds, Greensboro, NC (US); Aaron J. Drysdale, Oak Ridge, NC (US); Ronald Philip Klinc, Wake Forest, NC (US); William Lucas Daniel, Greensboro, NC (US)

(21) Appl. No.: 15/785,117

(22) Filed: Oct. 16, 2017

Related U.S. Application Data
(60) Provisional application No. 62/409,175, filed on Oct. 17, 2016.

(51) Int. Cl. G07F 17/16; G06Q 30/02; G07F 15/00

(52) U.S. Cl. CPC G07F 17/16; G07F 15/001; G06Q 30/0268

(57) ABSTRACT

A promotion server is provided including a promotion processing circuitry configured to receive transaction data from a point-of-sale device (POS) for a fueling environment. The POS is configured to facilitate a sale of goods or services and includes POS processing circuitry configured to receive the transaction data indicative of a good or service. The promotion processing circuitry is further configured to determine promotional data associated with one or more promotions based on the transaction data and cause display data associated with the one or more promotions to be transmitted to a display to be displayed to a customer. Only the promotion server performs the determination of promotional data.

### PRIORITY CLAIM

This application is based upon and claims the benefit of U.S. provisional application Ser. No. 62/409,175, filed Oct. 17, 2016, which is relied upon and incorporated herein by reference in its entirety for all purposes.

### FIELD OF THE INVENTION

The present invention relates generally to service stations at which fuel is dispensed. More particularly, the present invention relates to a fuel dispensing environment including a distributed promotion system.

### BACKGROUND

Retail fueling environments usually include a plurality of fuel dispensers located in a forecourt area outside of a convenience store building. Typically, the fuel dispensers will each be equipped with pay-at-the-pump capability by which the customer can perform the fueling transaction using a user interface on the respective fuel dispenser. For example, the customer can present a credit or debit card using a card reader installed on the fuel dispenser's user interface to pay for the fuel without entering the store. In other cases, the customer may want or need to go into a convenience store to pay for the fuel or to purchase other items.

The convenience store will generally be equipped with a point-of-sale (POS) system to handle certain functions relating to transactions that occur in the retail fueling environment. For instance, the POS device may include software components adapted to display a graphical user interface (GUI). Transactions are recorded using the POS for inventory reconciliation and other recordkeeping purposes. In addition, the POS may allow the station's manager the ability to set options associated with the POS or the service station, such as the appearance of receipts issued by the station's dispensers.

### SUMMARY OF CERTAIN ASPECTS

The present invention recognizes and addresses the foregoing considerations, and others, of prior art construction and methods. In this regard, certain exemplary and non-limiting aspects of the present invention will now be described. These aspects are intended to provide some context for certain principles associated with the present invention, but are not intended to be defining of the full scope of the present invention.

A promotion server is provided including a promotion processing circuitry configured to receive transaction data from a point-of-sale device (POS) for a fueling environment. The POS is configured to facilitate a sale of goods or services and includes POS processing circuitry configured to receive an indication of the transaction data indicative of a good or service. The promotion processing circuitry is further configured to determine promotional data associated with one or more promotions based on the transaction data and cause display data associated with the one or more promotions to be transmitted to a display to be displayed to a customer. Typically, only the promotion server performs the determination of promotional data.

Additional embodiments may include apparatuses and methods similar to those described above with respect to the fuel dispensing environment. Different systems and methods of the present invention utilize various combinations of the disclosed elements and method steps as supported by the overall disclosure herein. Thus, combinations of elements other than those discussed above may be claimed. Moreover, the accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a retail fueling environment incorporating certain aspects in accordance with the present invention.

FIG. 2 is a diagrammatic representation showing additional details of the enhanced dispenser hub (EDH) of FIG. 1.

FIG. 3 is a diagrammatic representation showing additional details of a fuel dispenser shown in FIG. 1.

FIGS. 4-6 illustrate distributed promotion system architectures according to example embodiments of the present invention.

FIG. 7 illustrates a block diagram of one example of a processing circuitry according to an embodiment of the present invention.

FIG. 8 illustrates a method of utilizing a promotion server according to an example embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Within the convenience retail industry, solutions have been offered for a customer-facing display that interfaces to the Point of Sale system (POS) and provides interactive content based on the current purchase, customer profile, weather, or other factors. Most previous implementations place the transaction evaluation logic that drives this behavior within the promotional display device itself. In this architecture, the transactional information is obtained by intercepting the data from physical devices or interpreting the data from journal records that were not originally designed for this purpose. These mechanisms were adopted so the solution could be implemented in a mode that was transparent to the POS. These solutions, however, require hardware to translate signals from POS peripherals and lack functionality that would be possible from a direct and intentional interface to the POS. Other implementations may be performed directly by the POS, which offers a high level of integration with the POS logic. But, the side effect is that the display is POS-specific and not usable by other POS systems.

A distributed promotion system architecture provided herein may be advantageously based on a direct interface between the point of sale device and a transaction logic/consumer interface handler, e.g. promotion server. The transaction interpretation logic is preferably separate from the display device, such as in the promotion server. As a result, the distributed promotion system need not be reliant on physical hardware, allowing for the promotion server and/or display to be placed in a variety of locations in a fueling environment. In some instances, the proportional server may be located remotely from the fueling environment.

In an example embodiment, the promotion server which determines the promotion data based on the transaction data may be separate from the device displaying the promotions. By separating the function of displaying the promotion from the computationally intensive determination of the promotional content, the requirements for on-site hardware may be significantly reduced. In some instances, the content may be displayed on a wired or wireless computing devices such as a tablet computer, such as by utilizing HTML or other markup language, which may allow for one or more displays to be positioned in locations throughout the forecourt. For example, customer displays may be positioned in fuel dispensers, or promotional displays adjacent to the cash registers.

The distributed transaction system may also reduce or eliminate processing of non-transaction data at the POS, which may be advantageous for financial information security. Additionally, a promotion server located remotely from the POS and/or fueling environment may have greater database access and/or processing capability. The increase in database access and processing capability may enable an increase in variables used to determine promotions to offer in a timely manner, e.g. in real time or near real time. Further, a remotely-located promotion server also provides segmentation of these resources from a directly integrated connection to the site network infrastructure. This segmentation facilitates easier site compliance with security regulations, including PCI DSS.

### Example Fueling Environment

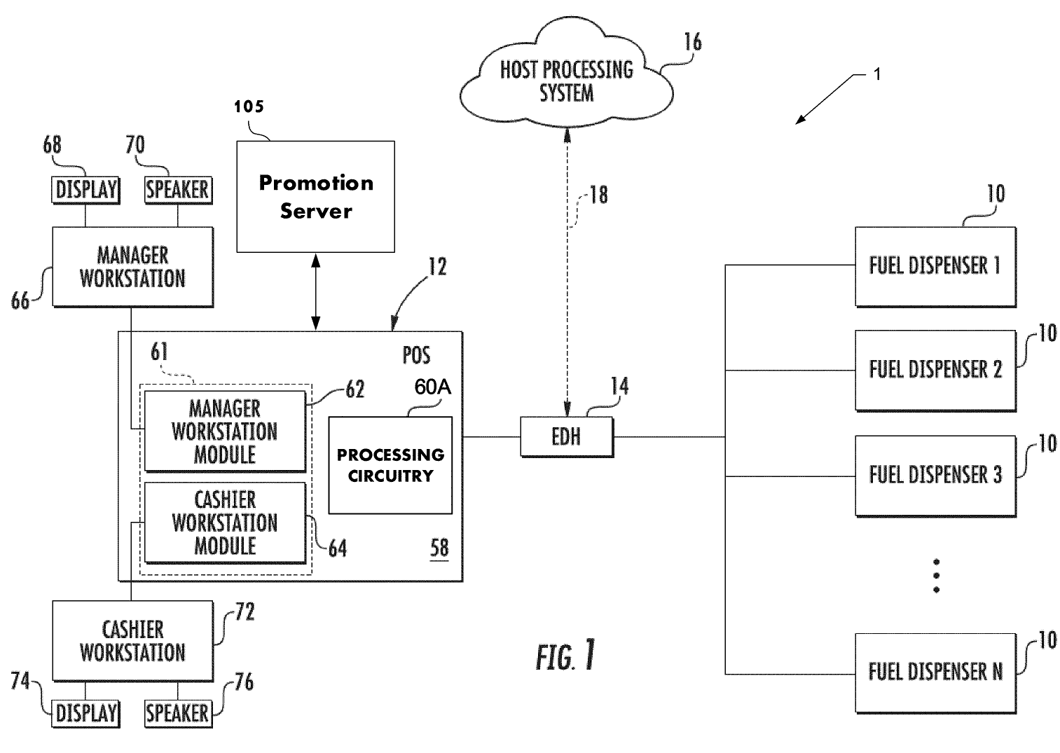

FIG. 1 illustrates an exemplary retail fueling environment 1 in accordance with an embodiment of the present invention. One or more fuel dispensers 10 are located in the forecourt region of the retail fueling environment. The fuel dispensers 10 are operative to dispense fuel supplied from one or more underground storage tanks (USTs) into a customer's vehicle. Typically, the fuel dispensers 10 will be provided with “pay-at-the-pump” capability, allowing the customer to authorize and pay for the fueling transaction at the dispenser itself. The retail fueling environment 1 also includes a point-of-sale (POS) system 12 that handles in-store sales activities, as well as various inventory and configuration functions.

Although embodiments are contemplated in which the electronic payment server is incorporated into or is in direct communication with POS 12, the illustrated embodiment utilizes an enhanced dispenser hub (EDH) 14 as shown and described in U.S. Pat. No. 8,438,064 (incorporated fully herein by reference for all purposes). EDH 14 includes an electronic payment server that allows processing of payment card information. In particular, credit (or debit) card information from the fuel dispensers 10 and any in-store card readers is fed to EDH 14, which seeks approval from a remote host processing system 16 via a suitable off-site communication link 18.

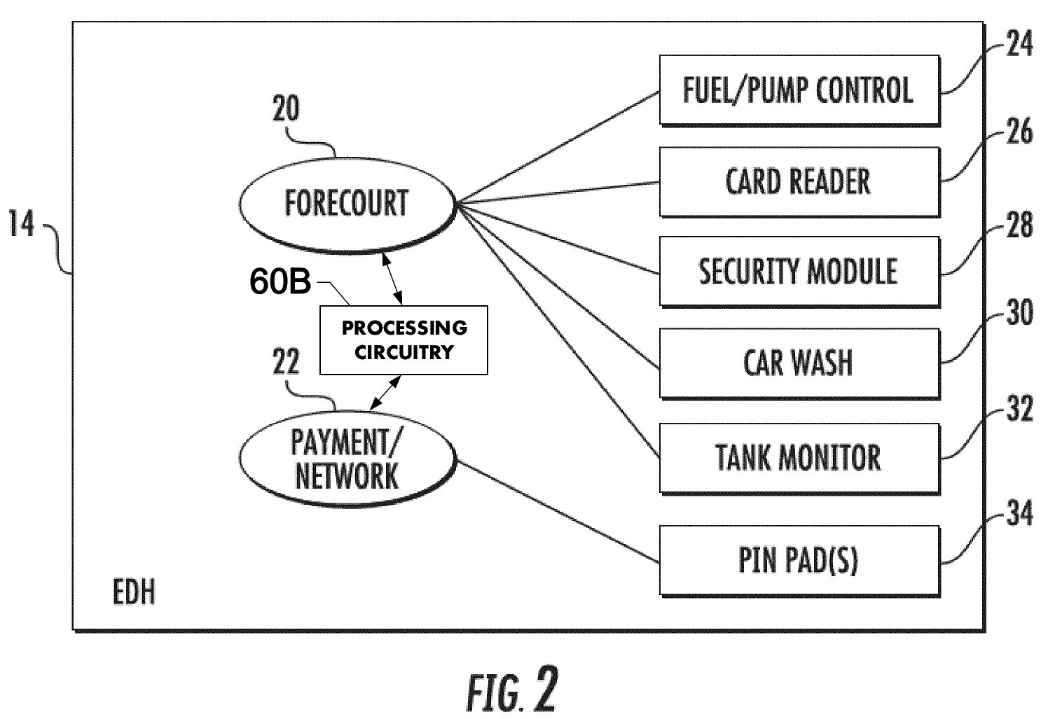

Referring now to FIG. 2, EDH 14 includes processing circuitry 60B for running a forecourt module 20 and a payment/network module 22. Forecourt module 20 is adapted to control the operation of devices located in the retail fueling environment's forecourt. In this example, forecourt module 20 comprises several modules, including fuel/pump control module 24, card reader module 26, security module 28, car wash module 30, and tank monitor module 32. The fuel/pump control module 24 handles operation of dispensers 10, while the car wash module 30 handles operation of any on-site car washes. The tank monitor module 32 handles operation of any tank monitors connected to the underground storage tanks of the retail fueling environment. The card reader module 26 handles operation of the card readers of the retail fueling environment, such as the card readers of dispensers 10. The security module 28 handles encryption of the sensitive information transmitted by the components of the retail fueling environment. For instance, payment card data received by the various card readers in the retail fueling environment may be handled by the card reader module 26 and encrypted by the security module 28.

Payment module 22 performs validation of the payment card information received by the various card readers in the retail fueling environment. In particular, payment module 22 handles communications to and from the host processing system 16. As shown, payment module 22 communicates with a PIN pad module 34 when information from a PIN pad is necessary to process the transaction.

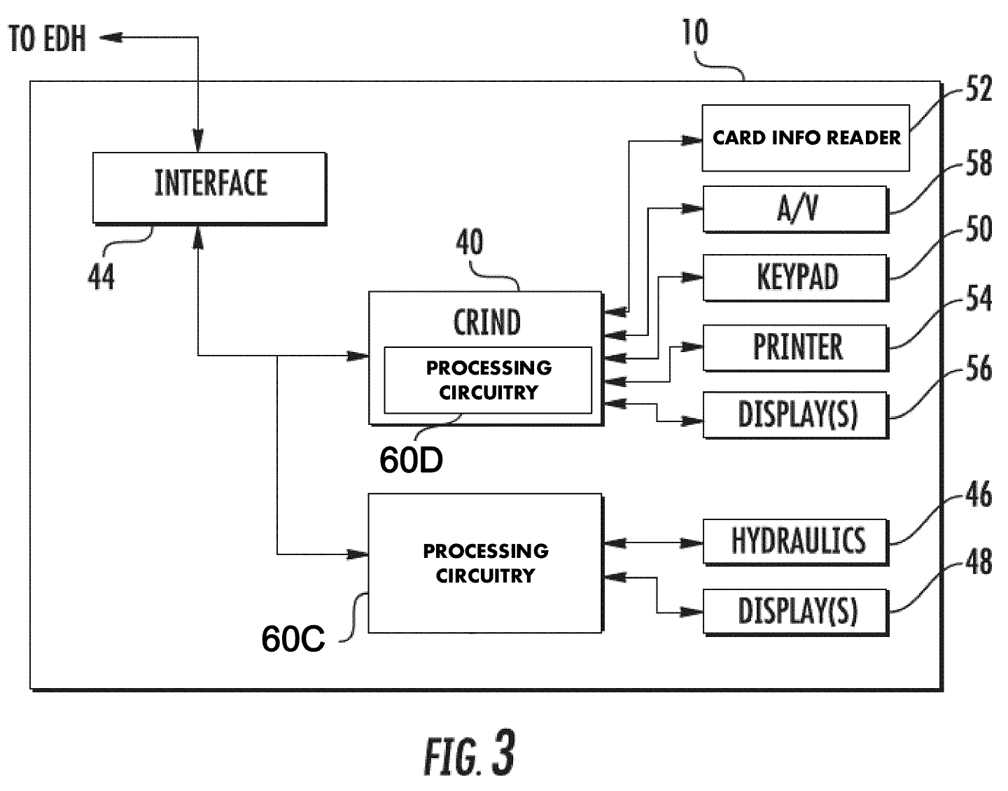

Referring now to FIG. 3, additional details regarding the various components of fuel dispenser 10 can be more easily explained. As shown, fuel dispenser 10 includes processing circuitry 60C. In addition, dispenser 10 may also comprise a CRIND module 40 which may be associated with or include processing circuitry 60D. Those of ordinary skill in the art are familiar with CRIND units used in fuel dispensers, but additional background information is provided in U.S. Pat. No. 4,967,366, the entirety of which is incorporated by reference herein for all purposes.

As shown, processing circuitry 60C and CRIND module 40, of the fuel dispenser 10, are in operative communication with EDH 14 via an interface 44. In addition, either or both of processing circuitry 60C and CRIND module 40 may be in wired or wireless communication with the internet and/or one or more cloud servers via off-site communication link 18, as depicted in FIG. 1, or another suitable communication link.

Processing circuitry 60C includes the hardware and software necessary to control the hydraulic components and functions of dispenser 10. Those of ordinary skill in the art are familiar with the operation of the hydraulics 46 of dispenser 10. In general, however, fuel from USTs is pumped through a piping network into an inlet pipe at the fuel dispenser. Fuel being dispensed passes through a flow meter, which is responsive to flow rate or volume. A displacement sensor, such as a pulser, is employed to generate a signal in response to fuel flow though the meter and communicate this information to processing circuitry 60C. Processing circuitry 60C may also provide control signaling to a valve that may be opened and closed to permit or not permit dispensing of fuel.

Meter flow measurements from the displacement sensor are collected by processing circuitry 60C. Processing circuitry 60C also typically performs calculations such as cost associated with a fuel dispensing transaction. As a dispensing transaction progresses, fuel is then delivered to a hose and through a nozzle into the customer's vehicle. Dispenser 10 typically includes a nozzle boot, which is used to hold and retain the nozzle when not in use. The nozzle boot may include a mechanical or electronic switch in communication with processing circuitry 60C to indicate when the nozzle has been removed for a fuel dispensing request and when the nozzle has been replaced, signifying the end of a fueling transaction. Processing circuitry 60C may thus determine whether a transaction has been initiated or completed.

Processing circuitry 60C may further be operative to control one or more displays 48 on the fuel dispenser. For example, a transaction price total display may present customers with the price for fuel that is dispensed. A transaction gallon total display may be used to present customers with the measurement of fuel dispensed in units of gallons (or liters). Finally, price per unit (PPU) displays may be provided to show the price per unit of fuel dispensed in either gallons or liters, depending on the programming of dispenser 10.

CRIND module 40 includes processing circuitry 60D configured to support payment processing and peripheral interfaces at dispenser 10. In this regard, CRIND module 40 may be in operative communication with several input devices. For example, a PIN pad 50 is typically used for entry of a PIN if the customer is using a debit card for payment of fuel or other goods or services. CRIND module 40 may also be in operative communication with a card information reader 52 for accepting credit, debit, or other magnetic stripe cards (or chip cards) for payment. Additionally, card information reader 52 may accept loyalty or program-specific cards as is well known. Further, CRIND module 40 may be in operative communication with other payment or transactional devices such as a receipt printer 54.

One or more display(s) 56 may be used to display information, such as transaction-related prompts and advertising, to the customer. The customer may use soft keys to respond to information requests presented to the user via a display 56. In some embodiments, however, a touch screen may be used for display 56. In this case, display 56 may be configured to display a virtual keypad for receiving payment data such as a PIN of a debit card or the billing postal (zip) code sometimes required for use of a credit card, for instance. Display 56 may also be used in this case to receive a selection from the customer regarding the displayed information.

Audio/video electronics 58 are adapted to interface with the CRIND module 40 and/or an auxiliary audio/video source to provide advertising, merchandising, and multimedia presentations to a customer in addition to basic transaction functions. The graphical user interface provided by the dispenser may allow customers to purchase goods and services other than fuel at the dispenser. For example, the customer may purchase a car wash and/or order food from the store while fueling a vehicle.

Referring again to FIG. 1, POS 12 includes a computer 58 having processing circuitry 60A. In the present example, processing circuitry 60A executes several software modules including manager workstation module 62 and cashier workstation module 64. When executed, manager workstation module 62 displays a GUI on manager workstation 66 that allows the owner, operator, or manager of the fueling station to set options for the fueling environment. Manager workstation module 66 is also adapted to provide point-of-sale (“POS”) capabilities, including the ability to conduct transactions for items offered for sale by the fueling station. Toward this end, manager workstation 66 includes a suitable display 68, such as a touchscreen display, and may further include one or more speakers 70. As one skilled in art will appreciate, computer 58 and manager workstation 66 may be incorporated into the same hardware.

Similarly, cashier workstation module 64 provides the station's cashier, clerk, or employee the means necessary to effect a transaction for one or more items or services offered by the fueling station. Cashier workstation module 64 communicates with the hardware of cashier workstation 72, which includes its own display 74 and optional speaker(s) 76.

In operation, a user positions a vehicle adjacent to one of dispensers 10 and uses the dispenser to refuel the vehicle. For payment, the user inserts and removes a payment card from card information reader 52. Card information reader 52 reads the information on the payment card and transmits the information to forecourt module 20 via the CRIND module 40 and card reader module 26. The forecourt module 20 provides the payment information to network payment module 22, which contacts host processing system 16 operated by the financial institution associated with the user's payment card. The financial institution either validates or denies the transaction and transmits such a response to network payment module 22. The information received from the financial institution's host computer system is transmitted from network payment module 22 back to forecourt module 20 to handle appropriately. This may include transmitting to dispenser 10 a request that the user provide another payment card if the transaction is denied, or printing a receipt if authorized.

For additional information regarding retail fueling environments, reference is made to U.S. Pat. Nos. 6,435,204 (entitled “Fuel Dispensing System”), 5,956,259 (entitled “Intelligent Fueling”), 5,734,851 (entitled “Multimedia Video/Graphics in Fuel Dispensers”), 6,052,629 (entitled “Internet Capable Browser Dispenser Architecture”), 5,689,071 (entitled “Wide Range, High Accuracy Flow Meter”), and 6,935,191 (“entitled “Fuel Dispenser Fuel Flow Meter Device, System and Method”), all of which are hereby incorporated by reference for all purposes as if set forth verbatim herein.

The POS 12 may also be in communication with a promotion server 105. The POS 12 may transmit transaction data to the promotion server 105, which may determine one or more promotions to display to a customer. The promotion server 105 may transmit display data associated with the one or more promotions to a display associated with the POS 12, the fuel dispenser 10, or elsewhere in the fueling environment to be displayed to the customer during a purchase transaction.

### Example Distributed Promotion System

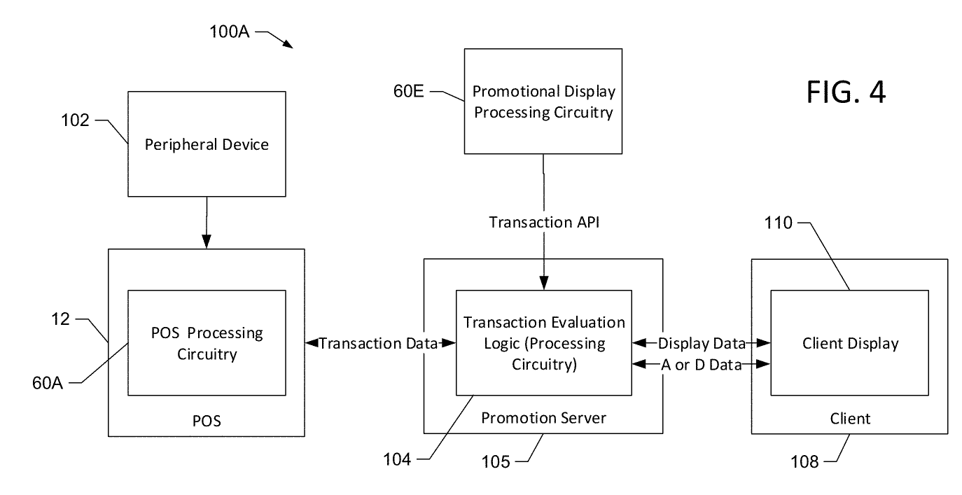

FIGS. 4-6 depict configurations and data communications of a distributed promotion system 100 including the promotion server 105, the POS 12, and a display. In the example depicted in FIG. 4, the transaction system 100A includes a peripheral device 102, the POS 12, the promotional server 105, and a client 108. The peripheral device 102 may include a scanner, such as a barcode scanner, a touch screen, such as display 74 associated with the cashier workstation 72, a keyboard, or the like, configured to receive transaction data indicative of a good or service. The transaction data may also include the commencement of the transaction, e.g. start transaction, and/or completion of transaction, e.g. sale complete or canceled. In an example embodiment, the POS may receive transaction data from a fuel dispenser 10, such as a fuel or a car wash. In some embodiments, the peripheral device 102 may be configured to receive customer data, such as a loyalty account number, which may be entered on a keyboard, read form a loyalty card, or the like. In an example embodiment, the peripheral device 102 may include a biometric reader or imaging device, e.g. camera. The peripheral device 102 may be configured to receive customer data including customer biometrics, e.g. fingerprint, retinal scan, or the like, and/or images for customer tracking and identification. In some example embodiments, the transaction data may include the customer data.

The POS 12 may receive the transaction data from the peripheral device and/or receive an indication of a selected good or service and generate the transaction data. The POS 12 may transmit the transaction data to the promotional server 105. The promotional server may be located within the fueling environment, such as within the store, but separate from the POS, or may be located remotely from the fueling environment, such as an off-site or cloud computing device or server.

The promotional server 105 may include processing circuitry including transaction evaluation logic 104. The transaction evaluation logic 104 may be controlled by a point of sale promotional configuration and control system, e.g. promotional display processing circuitry 60E. The promotional display processing circuitry 60E may control the current software configuration of the transaction evaluation logic 104 through a transaction application program interface (API). The software configuration may include the logic algorithms used in determination of promotions to display to consumers, goods or services which may be promoted or discounted, promotional data, customer data, or the like.

The transaction evaluation logic 104 may receive the transaction data from the POS 12 and determine one or more promotions to display to a customer based on the transaction data. For example, the transaction evaluation logic 104 may receive transaction data indicative of fuel being purchased and determine that a promotion for a car wash should be displayed. In some instances, the determination of promotions by the transaction evaluation logic may be further based on weather data, such as local weather of the fueling environment 1, e.g., determining promotions of hot drinks on cold days and cold drinks on warm days. In an example embodiment, the determination of promotions by the transaction evaluation logic 104 may be further based on inventory or expiration of inventory, for example, the transaction evaluation logic 104 may determine promotions based on a excess of an inventory item or if an inventory item is nearing an expiration date. In some example embodiments, the determination of promotions by the transaction evaluation logic 104 may be further based on historical transaction data, e.g., items which are commonly purchased together, such as a bag of chips with a soda. In some example embodiments, the determination of promotions by the transaction evaluation logic may be further based on customer specific historical transaction data. For example, if the customer commonly purchases a coffee in the morning and a soda in the evening, offering a promotion for a larger size, a discount for a second coffee or soda, or the like. The customer specific historical transaction data may be based on customer data, including biometric data, loyalty account data, facial recognition of a customer from a captured image, or the like.

In some example embodiments, the transaction evaluation logic 104 may be further configured to determine a probability of acceptance of the one or more of the available promotions. The determination of the one or more promotions may include a determination of an acceptance probability score, e.g. 50 percent, 70, percent, 90, percent, or the like. The transaction evaluation logic 104 may assign or determine the acceptance probability score for one or more promotions based on the transaction data, weather data, historical transaction data, customer specific historical transaction data, or the like. For example, the acceptance probability score for a promotion for a coffee may be higher in the morning, on cold days, with customers purchasing a donut, or with a historical purchase or a coffee, and lower in the evening, a warm day, with customers purchasing gummy bears, or customers with no coffee purchase history.

The transaction evaluation logic 104 may determine one or more promotions to display to the customer based on the acceptance probability score. For example, the transaction evaluation logic 104 may determine a promotion to display based on the promotion having the highest acceptance probability score. In some example embodiments, the transaction evaluation logic 104 may determine a plurality of promotions to display, for example the transaction evaluation logic may select a predetermined number of promotions, such as 3, 4, 6, or the like, or all promotions satisfying, e.g. exceeding, a predetermined acceptance threshold, such as 80 percent, 90 percent, or the like. In some example embodiments, the transaction evaluation logic 104 may determine an order in which the plurality of promotions will be displayed, such highest to lowest acceptance probability score.

The promotion server 105 may cause display data associated with the promotions to be transmitted to a display where it will be seen by a customer. In the example depicted in FIG. 4, a client 108 of the promotion server 105 includes a client display 110. The client 108 may be a wired or wireless computing device, such as a tablet computer, personal data assistant (PDA), smart phone, or the like. The client 108 may be positioned in various positions throughout the fueling environment 1, such as at or near a cash register or transaction kiosk in the store, as a portion of the fuel dispenser, e.g. display 56, or the like. In some example embodiments, the display data may be provided to an IP address as a server sent event (SSE) in a markup language, such as HTML5 (hyper text markup language). The client 108 may be configured to display content provided at the IP address.

In an example embodiment, the client 108 may be a customer smart phone. The customer smart phone may receive requests, such as a push notification, to view promotions based on proximity to a fuel dispenser 10, the POS 12, a promotional display, or the like. The costumer may allow the request, such as by touching “yes” or “allow” on a user interface. The client 108 may open an internet browser to show the display data.

In some instances the client may be further configured to receive an acceptance or declination (A or D) of one or more promotions. In an example embodiment in which a customer declines an offer, such as by user input on a touch screen or user interface, the client 108 may transmit declination of promotion data to the transaction evaluation logic 104. The transaction evaluation logic may cause the display data to advance to another promotion of the determined promotions and remove the declined promotion from a rotation of the promotion data to display to the current customer. In an instance in which the customer accepts the promotion, the client 108 may be configured to transmit acceptance data, indicating the displayed promotion accepted, to the transaction evaluation logic 104. The transaction evaluation logic 104 may generate additional transaction data based on the acceptance data and cause the additional transaction data to be transmitted to the POS to be added to a current transaction. For example, the costumer may accept a promotion for a discounted coffee during fueling at the fuel dispenser 10 or at the register at the POS 12, which may be added to the transaction for payment.

In an example embodiment, the transaction evaluation logic 104 may cause the promotions to be displayed during an active transaction period and discontinue displaying the promotions when the transaction is no longer active. The transaction evaluation logic 104 may determine the transaction is active based on transaction data indicative of commencement of a transaction, e.g. first item scanned or entered, fueling nozzle removed from fuel nozzle cradle, or the like. The transaction evaluation logic 104 may determine a transaction is no longer active based on transaction data indicative that a transaction is complete, e.g. a clerk selecting a display transaction total, a payment selection, or completed payment.

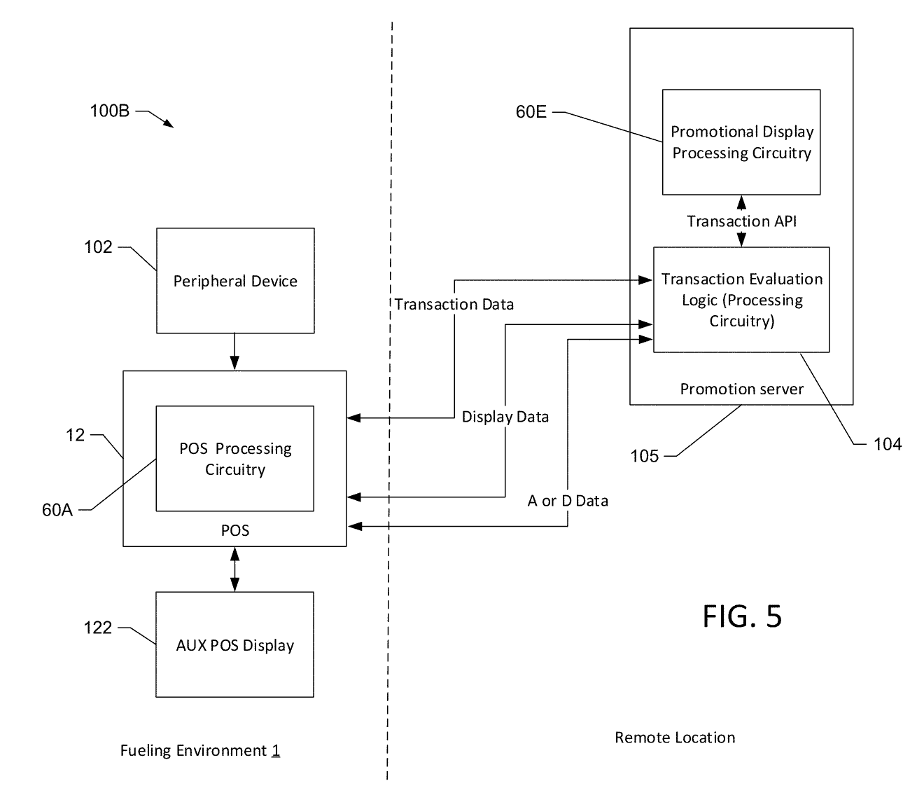

The promotion system 100B depicted in FIG. 5 is similar in some respects to the promotion system 100A of FIG. 4. In this case, however, the client 108 functions discussed above in reference to FIG. 4 are performed by the POS 12. The promotions are displayed on an auxiliary POS display 122, for example a customer facing display.

In an example embodiment, the promotion server 105 of promotion system 100B is located remotely from the fueling environment 1, such as a cloud server, remote computing device, or the like. In some example embodiments, the promotional display processing circuitry 60E is also provided as a portion of the promotion server 105.

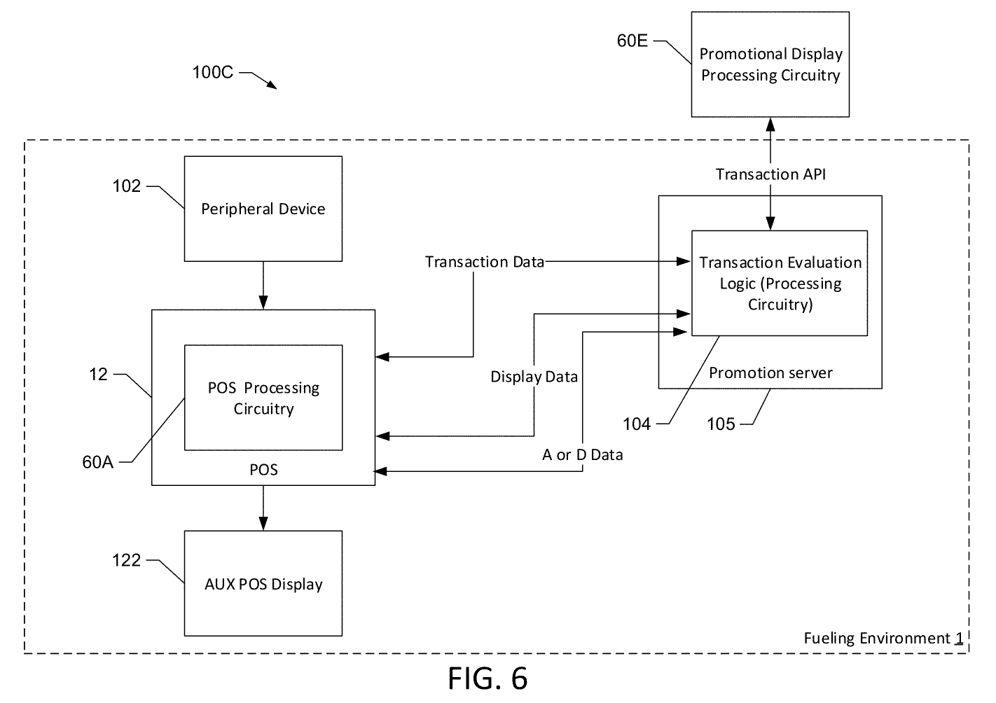

FIG. 6 depicts another example promotion system 100C, which is similar in some respects to promotion system 100B as depicted above in FIG. 5. In this case, the promotion server 105 is locally within the fueling environment, but remotely from the POS 12. In the depicted example the promotional display processing circuitry 60 may be separate from the promotion server 105 and may also be located remotely from both the promotion server and the fueling environment 1. Having the promotional server 105 and/or the promotional display processing circuitry 60E remote from the POS 12 and fueling environment 1 may allow for remote updates to the promotions, and/or promotion logic without interaction with the POS or requiring a technician to visit the fueling environment 1. It will be appreciated that a distributed architecture in accordance with the present invention provides various security benefits. For example, the promotional server may need an interface to external hosts to perform its assessment of which promotions are most favorable (integration to a weather forecast host, a customer identification host, a host that performs store traffic pattern analysis, etc.). With each additional external connection from an external host into the site networking infrastructure, there are additional security concerns. Additionally, there are significant benefits in scaling up these interfaces when they are connected to the cloud instead of to each individual site.

In some example embodiments, such as those described above, the display data associated with the promotions determined to be displayed are also transmitted to the POS 12 to be displayed on a display 74 facing the cashier. Specifically, the promotions displayed on the client display 110 or the POS display 122 may be synchronized with the promotions displayed on the display 74 facing the cashier (e.g., in a “window” provided in the cashier GUI). In this case, the cashier may suggest acceptance of one or more of the promotions to the customer, thus reinforcing the promotion. Displaying the display data associated with the determined promotions on the display 74 facing the cashier, e.g. a POS touch screen interface, may limit or eliminate a need for a secondary display to display the promotions to the cashier. Additionally, displaying the display data associated with the determined promotions on the a POS touch screen interface, may increase the attentiveness of the cashier to further promote the promotions since the display data is displayed on the POS interface the cashier may be interacting with to complete the transaction, instead of a secondary display.

In addition, the PIN pads located inside the store will typically have small displays for instructing the customer on when and how to swipe or insert their debit or credit card to make payment for the transaction. In accordance with the present invention, this PIN pad display can be considered an additional POS display 122 for showing the promotional message. In particular, promotion server 105 will transfer the PIN pad promotional message to the POS and/or EDH (if the promotion server is a separate device) to be shown between transactions. It will appreciated that the promotional message shown on the PIN pad may be the same as the message on the full-size promotion display, or an abbreviated version adapted for the small size of the PIN pad display but which supports the full-size message.

### Example Processing Circuitry

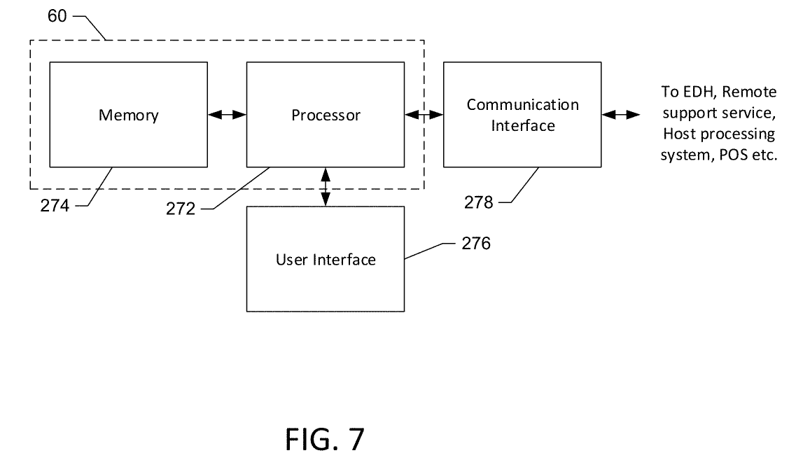

FIG. 7 shows certain elements of processing circuitry 60 for a POS 12, EDH 14, fueling dispenser 10, CRIND module 40, and/or promotion server 105. The processing circuitry 60 of FIG. 7 may be employed, for example, on onboard circuitry within the POS 12, EDH 14, fueling dispenser 10, CRIND module 40, and/or promotion server 105, in circuitry associated with a convenience store, a network device, server, proxy, or the like, as discussed above in reference to processing circuitry 60A, 60B, 60C, 60D, and 60E of FIGS. 1-6 and/or the transaction evaluation logic 104 of FIGS. 4-6. Alternatively, embodiments may be employed on a combination of devices. Furthermore, it should be noted that the devices or elements described below may not be mandatory and thus some may be omitted in certain embodiments.

In an example embodiment, the processing circuitry 60 is configured to perform data processing, application execution and other processing and management services. In one embodiment, the processing circuitry 60 may include a memory 274 and a processor 272 that may be in communication with or otherwise control a user interface 276 and a communication interface 278. As such, the processing circuitry 60 may be embodied as a circuit chip (e.g. an integrated circuit chip) configured (e.g. with hardware, software or a combination of hardware and software) to perform operations described herein. However, in some embodiments, the processing circuitry 60 may be embodied as a portion of a server, computer, or workstation. In situations where the processing circuitry 60 is embodied as a server or at a remotely located computing device, the user interface 276 may be disposed at another device (e.g. at a computer terminal or client device such as the fuel dispenser 10) that may be in communication with the processing circuitry 60 via the communication interface 278 and/or a network.

The network may be a data network, such as a local area network (LAN), a metropolitan area network (MAN), a wide area network (WAN) (e.g. the Internet), and/or the like, which may couple to devices such as processing elements (e.g. computer terminals, server computers or the like) and/or databases.

The user interface 276 may be an input/output device for receiving instructions directly from a user. The user interface 276 may be in communication with the processing circuitry 60 to receive user input via the user interface 276 and/or to present output to a user as, for example, audible, visual, mechanical or other output indications. The user interface 276 may include, for example, a keyboard, a mouse, a joystick, a display (e.g. a touch screen display), a microphone, a speaker, or other input/output mechanisms. Further, the processing circuitry 60 may comprise, or be in communication with, user interface circuitry configured to control at least some functions of one or more elements of the user interface 276. The processing circuitry 60 and/or user interface circuitry may be configured to control one or more functions of one or more elements of the user interface 276 through computer program instructions (e.g. software and/or firmware) stored on a memory device accessible to the processing circuitry 60 (e.g. volatile memory, non-volatile memory, and/or the like). In some example embodiments, the user interface circuitry is configured to facilitate user control of at least some functions of the apparatus through the use of a display configured to respond to user inputs. The processing circuitry 60 may also comprise, or be in communication with, display circuitry configured to display at least a portion of a user interface 276, the display and the display circuitry configured to facilitate user control of at least some functions of the apparatus.

The communication interface 278 may be any means such as a device or circuitry embodied in either hardware, software, or a combination of hardware and software that is configured to receive and/or transmit data from/to a network and/or any other device or module in communication with the processing circuitry 60, the POS 12, and/or EDH 14 of the fueling environment (and/or a remote cloud server, either directly or via a router located in the convenience store). In some instances the communications interface 278 may be referred to as a cloud connection processor (CCP) and may provide secured, e.g. encrypted, communication between the processing circuitry, the network, and/or remote servers. The communication interface 278 may also include, for example, an antenna (or multiple antennas) and supporting hardware and/or software for enabling communications with the network or other devices (e.g. a user device). In some environments, the communication interface 278 may alternatively or additionally support wired communication. As such, for example, the communication interface 278 may include a communication modem and/or other hardware/software for supporting communication via cable, digital subscriber line (DSL), universal serial bus (USB) or other mechanisms. In an exemplary embodiment, the communication interface 278 may support communication via one or more different communication protocols or methods. In some cases, IEEE 802.15.4 based communication techniques such as ZigBee or other low power, short range communication protocols, such as a proprietary technique based on IEEE 802.15.4 may be employed along with radio frequency identification (RFID) or other short range communication techniques.

### Example Flowchart(s) and Operations

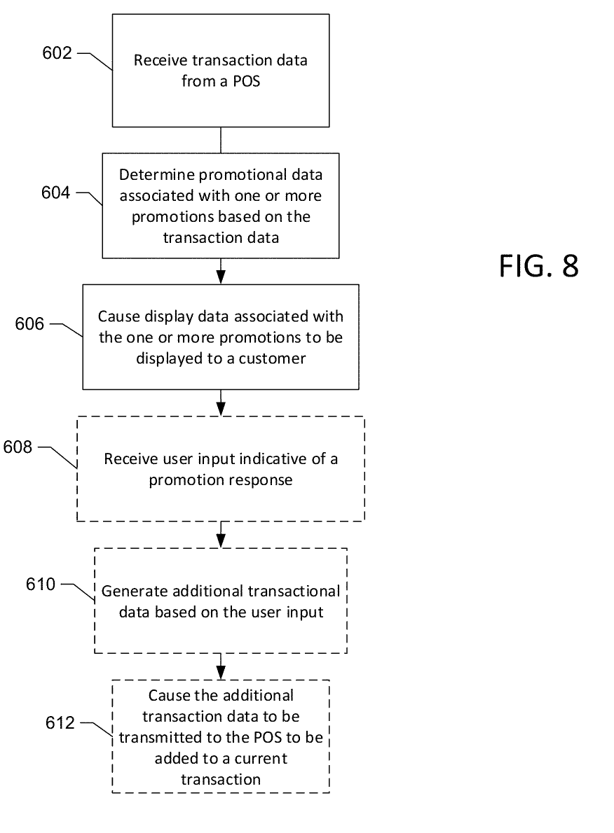

Embodiments of the present invention provide methods, apparatus and computer program products for operating a transaction system. Various examples of the operations performed in accordance with embodiments of the present invention will now be provided with reference to FIG. 8.

FIG. 8 illustrates a flowchart according to an example method for operating a promotion system according to an example embodiment. The operations illustrated in and described with respect to FIG. 8 may, for example, be performed by, with the assistance of, and/or under the control of one or more of the processor 272, memory 274, communication interface 278, and/or user interface 274. The method may include receiving transaction data from a POS at operation 602, determining promotional data associated with one or more promotions based on the transaction data at operation 604, and causing display data associated with the one or more promotions to be displayed to a customer at operation 606.

In some embodiments, the method may include additional, optional operations, and/or the operations described above may be modified or augmented. Some examples of modifications, optional operations, and augmentations are described below, as indicated by dashed lines, such as, receiving a user input indicative of a promotion response at operation 608, generating additional transaction data at operation 610, and causing the additional transaction data to be transmitted to the POS to be added to a current transaction at operation 612.

FIG. 8 illustrates a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 274 and executed by, for example, the processor 272. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

In some embodiments, the system may be further configured for additional operations or optional modifications. In this regard, in an example embodiment, the promotion server is located remotely from the fueling environment. In some example embodiments, the promotion server is located remote from the POS and local to the fueling environment. In an example embodiment, the POS processing circuitry is further configured to receive the promotional data from the promotion server and cause the one or more promotions to be displayed on a POS customer display. In some example embodiments, the promotion processing circuitry is further configured to receive a user input indicative of a promotion response, generate additional transaction data based on the user input, and cause the additional transaction data to be transmitted to the POS to be added to a current transaction. In an example embodiment, the one or more promotions are displayed on a PIN pad display in lieu of or addition to other displays when the PIN pad is not being used for PIN entry. In some example embodiments, the one or more promotions are displayed on a wireless computing device. In an example embodiment, the one of more promotions are displayed on a tablet computer. In some example embodiments, the transaction data comprises customer data and determining the one or more promotions are further based on the customer data. In an example embodiment, the distributed transaction also includes a secured hub configured to process payment information, wherein the payment information is only processed by the secured hub within the fueling environment.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A distributed promotion system comprising:
a point-of-sale device (POS) for a fueling environment configured to facilitate a sale of goods or services, the POS comprising POS processing circuitry configured to:
receive transaction data indicative of a good or service; and
a promotion server comprising promotion processing circuitry configured to:
receive the transaction data from the POS;
determine promotional data associated with or more promotions based on the transaction data; and
cause display data associated with the one or more promotions to be transmitted to a display to be displayed to a customer,
wherein only the promotion server performs the determination of promotional data.

2. The distributed promotion system of claim 1, wherein the promotion server is located remotely from the fueling environment.

3. The distributed promotion system of clam 1, wherein the promotion server is located remote from the POS and local to the fueling environment.

4. The distributed promotion system of claim 1, wherein the display comprises a POS customer display and wherein the POS processing circuitry is further configured to:
receive the promotional data from the promotion server; and
cause the one or more promotions to be displayed on the POS customer display.

5. The distributed promotion system of claim 1, wherein the promotion processing circuitry is further configured to:
receive a user input indicative of a promotion response;
generate additional transaction data based on the user input; and
cause the additional transaction data to be transmitted to the POS to be added to a current transaction.

6. The distributed promotion system of claim 1, wherein the display comprises a PIN pad and the one or more promotions are displayed on the PIN pad.

7. The distributed promotion system of claim 1, wherein the display comprises a wireless computing device and the one or more promotions are displayed on the wireless computing device.

8. The distributed promotion system of claim 1, wherein the display comprises a tablet computer and the one of more promotions are displayed on the tablet computer.

9. The distributed promotion system of claim 1, wherein the transaction data comprises customer data and determining the one or more promotions are further based on the customer data.

10. The distributed promotion system of claim 1 further comprises:
a secured hub configured to process payment information, wherein the payment information is only processed by the secured hub within the fueling environment.

11. A promotion server comprising:
promotion processing circuitry configured to:
receive transaction data from a point-of-sale device (POS) for a fueling environment, wherein the POS is configured to facilitate a sale of goods or services, and wherein the POS comprises POS processing circuitry configured to receive an the transaction data indicative of a good or service;
determine promotional data associated with or more promotions based on the transaction data; and
cause display data associated with the one or more promotions to be transmitted to a display to be displayed to a customer,
wherein only the promotion server performs the determination of promotional data.

12. The promotion server of claim 11, wherein the promotion server is located remotely from the fueling environment.

13. The promotion server of clam 11, wherein promotion server is located remote from the POS and local to the fueling environment.

14. The promotion server of claim 11, wherein the display comprises a POS customer display and wherein the POS processing circuitry is further configured to:
receive the promotional data from the promotion server; and
cause the one or more promotions to be displayed on the POS customer display.

15. The promotion server of claim 11, wherein the promotion processing circuitry is further configured to:
receive a user input indicative of a promotion response;
generate additional transaction data based on the user input; and
cause the additional transaction data to be transmitted to the POS to be added to a current transaction.

16. The promotion server of claim 11, wherein the display comprises a PIN pad and the one or more promotions are displayed on the PIN pad.

17. The promotion server of claim 11, wherein the processing circuitry is further operative to cause display data associated with the one or more promotions to be transmitted to the point-of-sale device (POS) to be displayed on a graphical user interface of the point-of-sale device (POS).

18. The promotion server of claim 11, wherein the display comprises a wireless computing device and the one or more promotions are displayed on the wireless computing device.

19. The promotion server of claim 11, wherein the display comprises a tablet computer and the one of more promotions are displayed on a tablet computer.

20. The promotion server of claim 11, wherein the transaction data comprises customer data and determining the one or more promotions are further based on the customer data.

21. The promotion server of claim 11 further comprises:
a secured hub configured to process payment information, wherein the payment information is only processed by the secured hub within the fueling environment.
